(19) United States
(12) Patent Application Publication
(10) Pub. No.: US 2011/0193337 A1
(43) Pub. Date: Aug. 11, 2011

(54) FORGERY-PROOF SECURITY FEATURES IN SECURITY OR VALUE DOCUMENTS

(75) Inventors: Georgios TZIOVARAS, Wuppertal (DE); Mehmet-Cengiz YESILDAG, Leverkusen (DE); Dirk POPHUSEN, Bergisch Gladbach (DE); Heinz PUDLEINER, Krefeld (DE); Norbert KINZEL, Koln (DE)

(73) Assignee: Bayer Material Science AG, LeverKusen (DE)

(21) Appl. No.: 13/120,837

(22) PCT Filed: Sep. 10, 2009
(86) PCT No.: PCT/EP2009/006559

§ 371 Date: Mar. 24, 2011

(30) Foreign Application Priority Data
Sep. 24, 2008 (EP) 08016743.0

(51) Int. Cl. B42D 15/00; B32B 3/00; B32B 38/06

(52) U.S. Cl. 283/113; 428/195.1; 156/272.8

(57) ABSTRACT

The present invention relates to a laminar structure comprising: a first layer comprising a first plastic film which comprises a thermoplastic and a filler and a second plastic film comprising a thermoplastic and a filler; a second layer comprising a third plastic film which comprises a thermoplastic and a filler and a second plastic film comprising a thermoplastic and a filler; and a laser printed watermark disposed on at least one of the plastic films positioned between the first and second layers.

The present invention relates to laminar structures consisting of thermoplastic layers containing printed security features together with a process for the production thereof and their use to increase protection against forgery in security or value documents, preferably in identity documents.

Watermarks as an identifying feature in postage stamps and as a means of increasing protection against forgery in banknotes, for example, are generally known. They are incorporated into the paper sheets at the manufacturing stage, such that the fibrous layer of the paper is thinner or thicker in the region of the watermark and the so-called watermark appears as a more transparent or more opaque image when the paper is held up to the light.

NL-A 8 900 016 describes the incorporation of so-called watermarks into plastics, for example plastic multi-layer composites or laminates. This is done by embossing them with an embossing stamp, as a result of which—as in paper production—thinner and thicker regions are produced within the plastic multi-layer composite which reveal the corresponding image when the composite is held up to the light.

However, watermarks of this type do not provide adequate protection against forgery, particularly in the case of identity documents such as for example identity cards, passports and credit cards, because it is possible to open up the layer or the laminate composite and replace the individual identification features, whilst the embossed watermark can remain unchanged in the document when it is sealed again so that the forgery remains undetected. There is therefore a desire to increase the protection of such documents against forgery by means of watermark-like security features which can be personalised such that a subsequent substitution of the individual identification features can be detected by comparison with the watermark-like security feature.

However, the use of embossing as a means of incorporating individual security features, i.e. such security features which in an extreme case can vary in every single security document, is not possible or is possible only at unacceptable cost, since a separate embossing stamp would be needed for each individual design and the resulting security feature would offer inadequate image quality and hence distinctiveness.

A further problem was that personalised security features of this kind have to survive the process of sealing a security or value document of this type, preferably identity document, such as for example the lamination of a multi-layer composite at elevated temperatures, without being damaged.

The object underlying the present invention was therefore to provide a simple means of incorporating a personalisable security feature into a laminar structure consisting of plastic layers which survives the sealing process for the resulting security or value document without being damaged.

This object was achieved according to the invention by laser printing a watermark as a security feature of this type onto an uncoated side of a plastic film within the laminar structure in such a way that it can only be detected in detail when the laminar structure is held up to the light but is undetectable or considerably more difficult to detect when the laminar structure is viewed from above. The use of laser printing to apply the watermark allows the security feature to be personalised, while at the same time the printed image is resistant to exposure to heat during the lamination process.

This solution according to the invention is all the more surprising because until now plastic films have been printed predominantly by means of analogue printing methods, such as offset, gravure or screen printing for example. Depending on the plastic film used, the films have to be pretreated in an appropriate manner for analogue printing methods. In the case of polyolefin films, for example, the surface energy of the film has to be increased by flame treatment or plasma treatment, for example, before it is printed. In addition, the application of ink in analogue printing methods is relatively thick, which means that solvents or similar constituents cannot be removed completely from the ink layer and may remain in the ink. This causes the film surface to peel or swell. However, a pretreatment of such plastic films for use in security documents is a weak point in the sealed, generally laminated laminar structure, by means of which such a document can be opened subsequently.

A laser printed impression also has the following advantages over other digital printing methods: very good print quality is combined with a high print speed. The impressions are resistant to sunlight, a property which can only be achieved with inkjet printers by using special inks. Laser printing costs are considerably lower, and the lifetime of the printers is significantly higher, than that of inkjet printers for example. In addition, laser printers can go for longer periods without the need for maintenance, since no drying out of the nozzles can occur, as with inkjet printers for example. The storage life of toners for laser printers is considerably longer in comparison.

The present invention therefore provides a laminar structure characterised in that it has at least one first layer consisting of at least one thermoplastic and at least one filler and a further layer consisting of at least one thermoplastic and at least one filler (“filled layers”), which filled layers were produced from at least one first plastic film consisting of at least one thermoplastic and at least one filler and at least one further plastic film consisting of at least one thermoplastic and at least one filler (“filled films”), wherein between the two filled layers there is at least one watermark applied by laser printing to at least one plastic film used in the production.

Within the context of the invention a watermark applied by laser printing is understood to be a laser printed security feature which is discernible to the observer only on holding the laminar structure up to the light, in other words to the human eye this security feature is more clearly discernible by holding the laminar structure up to light in the visible wavelength range from 380 nm to 780 nm than by viewing the laminar structure from above under incident light. When the laminar structure is viewed from above with no back light, this security feature is either undetectable or substantially more difficult to detect. This property of the security feature according to the invention is comparable with conventional watermarks. However, within the context of the present invention the watermark is incorporated into the material not by creating thinner and thicker regions in the material, for example by embossing, as with the known conventional watermarks, but by laser printing onto the film that is used.

The watermark(s) can be laser printed onto at least one of the two filled films.

Alternatively the laminar structure can have at least one further layer consisting of at least one thermoplastic between the two filled layers, wherein this layer between the two filled layers was produced from a transparent plastic film consisting of at least one thermoplastic, onto which the watermark(s) is (are) applied by laser printing.

Within the context of the invention the term transparent is understood to mean that the light transmission of this film in the visible wavelength range from 380 nm to 780 nm is at least 50%, preferably at least 65%, particularly preferably at least 80% and in most particularly preferred embodiments at least 90%.

The thermoplastic of the filled layer or the layer between the two filled layers can mutually independently preferably be at least one thermoplastic selected from polymers of ethylene-unsaturated monomers and/or polycondensates of bifunctional reactive compounds. For certain applications it can be advantageous to use a transparent thermoplastic.

Particularly suitable thermoplastics are polycarbonates or copolycarbonates based on diphenols, poly- or copolyacrylates and poly- or copolymethacrylates such as for example and preferably polymethyl methacrylate, polymers or copolymers with styrene such as for example and preferably transparent polystyrene or polystyrene acrylonitrile (SAN), transparent thermoplastic polyurethanes, and polyolefins such as for example and preferably transparent polypropylene types or polyolefins based on cyclic olefins (e.g. TOPAS®, Hoechst), poly- or copolycondensates of terephthalic acid such as for example and preferably poly- or copolyethylene terephthalate (PET or CoPET), glycol-modified PET (PETG) or poly- or copolybutylene terephthalate (PBT or CoPBT) or mixtures of the above.

Polycarbonates or copolycarbonates are most particularly preferred, in particular those having average molecular weights M_{W} of 500 to 100,000, preferably 10,000 to 80,000, particularly preferably 15,000 to 40,000 or blends thereof with at least one poly- or copolycondensate of terephthalic acid having average molecular weights M_{W} of 10,000 to 200,000, preferably 26,000 to 120,000. In particularly preferred embodiments of the invention the blend is a blend of polycarbonate or copolycarbonate with poly- or copolybutylene terephthalate. Such a blend of polycarbonate or copolycarbonate with poly- or copolybutylene terephthalate can preferably be a blend with 1 to 90 wt. % polycarbonate or copolycarbonate and 99 to 10 wt. % poly- or copolybutylene terephthalate, preferably with 1 to 90 wt. % polycarbonate and 99 to 10 wt. % polybutylene terephthalate, the proportions adding to 100 wt. %. Such a blend of polycarbonate or copolycarbonate with poly- or copolybutylene terephthalate can particularly preferably be a blend with 20 to 85 wt. % polycarbonate or copolycarbonate and 80 to 15 wt. % poly- or copolybutylene terephthalate, preferably with 20 to 85 wt. % polycarbonate and 80 to 15 wt. % polybutylene terephthalate, the proportions adding to 100 wt. %. Such a blend of polycarbonate or copolycarbonate with poly- or copolybutylene terephthalate can most particularly preferably be a blend with 35 to 80 wt. % polycarbonate or copolycarbonate and 65 to 20 wt. % poly- or copolybutylene terephthalate, preferably with 35 to 80 wt. % polycarbonate and 65 to 20 wt. % polybutylene terephthalate, the proportions adding to 100 wt. %.

In preferred embodiments aromatic polycarbonates or copolycarbonates are particularly suitable as polycarbonates or copolycarbonates.

The polycarbonates or copolycarbonates can be linear or branched in a known manner.

The production of these polycarbonates can take place in a known manner from diphenols, carbonic acid derivatives, optionally chain terminators and optionally branching agents. Details of the production of polycarbonates have been set out in many patent specifications over the last 40 years or so. By way of example reference is made here only to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertne’, BAYER AG, “Polycarbonates” in Encyclopedia of Polymer Science and Engineering, Volume 11, Second Edition, 1988, pages 648-718, and finally to Drs. U. Grigo, K. Kirchner and P. R. Milner “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pages 117-299.

Suitable diphenols can for example be dihydroxyaryl compounds having the general formula (I)

HO—Z—OH (I)

wherein Z is an aromatic radical having 6 to 34 C atoms, which can contain one or more optionally substituted aromatic nuclei and aliphatic or cycloaliphatic radicals or alkylaryls or heteroatoms as binding links.

Examples of suitable dihydroxyaryl compounds are: dihydroxybenzenes, dihydroxydiphenyls, bis-(hydroxyphenyl) alkanes, bis-(hydroxyphenyl)cycloalkanes, bis-(hydroxyphenyl) aryls, bis-(hydroxyphenyl)ethers, bis-(hydroxyphenyl) ketones, bis-(hydroxyphenyl) sulfides, bis-(hydroxyphenyl) sulfones, bis-(hydroxyphenyl) sulfoxides, 1,1′-bis-(hydroxyphenyl) diisopropylbenzenes, and the ring-alkylated and ring-halogenated compounds thereof.

These and other suitable dihydroxyaryl compounds are described for example in DE-A 3 832 396, FR-A 1 561 518, in H. Schnell, Chemistry and Physics of Polycarbonates, Interscience Publishers, New York 1964, p. 28 ff.; p. 102 ff. and in D. G. Legrand, J. T. Bendler, Handbook of Polycarbonate Science and Technology, Marcel Dekker New York 2000, p. 72 ff.

Preferred dihydroxyaryl compounds are for example resorcinol, 4,4′-dihydroxydiphenyl, bis-(4-hydroxyphenyl)methane, bis-(3,5-dimethyl-4-hydroxyphenyl)methane, bis-(4-hydroxyphenyl) diphenylmethane, 1,1-bis-(4-hydroxyphenyl)-1-phenylethane, 1,1-bis-(4-hydroxyphenyl)-1-(1-naphthyl)ethane, 1,1-bis-(4-hydroxyphenyl)-1-(2-naphthyl)ethane, 2,2-bis-(4-hydroxyphenyl)propane, 2,2-bis-(3-methyl-4-hydroxyphenyl)propane, 2,2-bis-(3,5-dimethyl-4-hydroxyphenyepropane, 2,2-bis-(4-hydroxyphenyl)-1-phenylpropane, 2,2-bis-(4-hydroxyphenyl)-hexafluoropropane, 2,4-bis-(4-hydroxyphenyl)-2-methylbutane, 2,4-bis-(3,5-dimethyl-4-hydroxyphenyl)-2-methylbutane, 1,1-bis-(4-hydroxyphenyl)cyclohexane, 1,1-bis-(3,5-dimethyl-4-hydroxyphenyl)cyclohexane, 1,1-bis-(4-hydroxyphenyl)-4-methylcyclohexane, 1,3-bis-[2-(4-hydroxyphenyl)-2-propyl]benzene, 1,1′-bis-(4-hydroxyphenyl)-3-diisopropylbenzene, 1,1′-bis-(4-hydroxyphenyl)-4-diisopropylbenzene, 1,3-bis-[2-(3,5-dimethyl-4-hydroxyphenyl)-2-propyl]-benzene, bis-(4-hydroxyphenyl)ether, bis-(4-hydroxyphenyl)sulfide, bis-(4-hydroxyphenyl)sulfone, bis-(3,5-dimethyl-4-hydroxyphenyl)sulfone and 2,2′,3,3′-tetrahydro-3,3,3′,3′-tetramethyl-1,1′-spirobi-[1H-indene]-5,5′-diol or

dihydroxydiphenyl cycloalkanes having the formula (Ia)

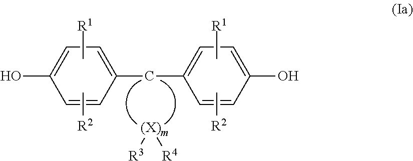

wherein
R¹ and R² mutually independently denote hydrogen, halogen, preferably chlorine or bromine, C₁-C₈ alkyl, C₅-C₆ cycloalkyl, C₆-C₁₀ aryl, preferably phenyl, and C₇-C₁₂ aralkyl, preferably phenyl-C₁-C₄ alkyl, in particular benzyl,
m denotes a whole number from 4 to 7, preferably 4 or 5,
R³ and R⁴ which can be chosen individually for each X, mutually independently denote hydrogen or C₁-C₆ alkyl and
X denotes carbon,
   with the proviso that on at least one X atom R³ and R⁴ both denote alkyl. In formula (Ia) R³ and R⁴ are preferably both alkyl on one or two X atoms, in particular on just one X atom.

The preferred alkyl radical for radicals R³ and R⁴ in formula (Ia) is methyl. The X atoms in the alpha position to the diphenyl-substituted C atom (C-1) are preferably not dialkyl substituted, whereas alkyl disubstitution in the beta position to C-1 is preferred.

Particularly preferred dihydroxydiphenyl cycloalkanes having formula (Ia) are those having 5 and 6 C-ring X atoms in the cycloaliphatic radical (m=4 or 5 in formula (Ia)), for example the diphenols having formulae (Ib) to (Id),

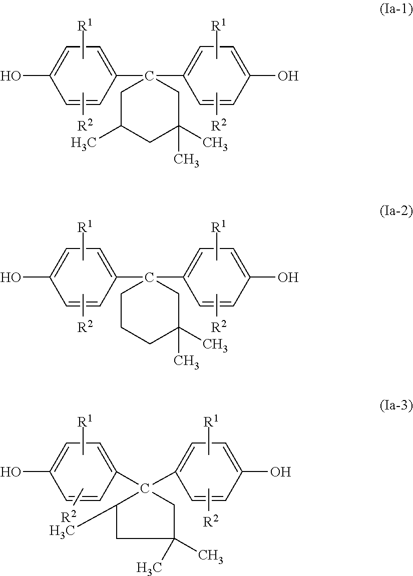

A most particularly preferred dihydroxydiphenyl cycloalkane having the formula (Ia) is 1,1-bis-(4-hydroxyphenyl)-3,3,5-trimethylcyclohexane (formula (Ia-1) where R¹ and R² are equal to I-1).

Such polycarbonates can be produced in accordance with EP-A 359 953 from dihydroxydiphenyl cycloalkanes having the formula (Ia.).

Particularly preferred dihydroxyaryl compounds are resorcinol, 4,4′-dihydroxydiphenyl, bis-(4-hydroxyphenyl)diphenylmethane, 1,1-bis-(4-hydroxyphenyl)-1-phenylethane, bis-(4-hydroxyphenyl)-1-(1-naphthyl)ethane, bis-(4-hydroxyphenyl)-1-(2-naphthyl)ethane, 2,2-bis-(4-hydroxyphenyl)propane, 2,2-bis(3,5-dimethyl-4-hydroxyphenyl)propane, 1,1-bis-(4-hydroxyphenyl)cyclohexane, 1,1-bis-(3,5-dimethyl-4-hydroxyphenyl)cyclohexane, 1,1-bis-(4-hydroxyphenyl)-3,3,5-trimethylcyclohexane, 1,1′-bis-(4-hydroxyphenyl)-3-diisopropylbenzene and 1,1′-bis-(4-hydroxyphenyl)-4-diisopropylbenzene.

Most particularly preferred dihydroxyaryl compounds are 4,4′-dihydroxydiphenyl, 2,2-bis-(4-hydroxyphenyl)propane and 1,1-bis-(4-hydroxyphenyl)-3,3,5-trimethylcyclohexane.

Both one dihydroxyaryl compound with formation of homopolycarbonates and also various dihydroxyaryl compounds with formation of copolycarbonates can be used. Both one dihydroxyaryl compound having formula (I) or (Ia) with formation of homopolycarbonates and also several dihydroxyaryl compounds having formula (I) and/or (Ia) with formation of copolycarbonates can be used. The various dihydroxyaryl compounds can be connected together either randomly or in blocks. In the case of copolycarbonates of dihydroxyaryl compounds having formula (I) and (Ia) the molar ratio of dihydroxyaryl compounds having formula (Ia) to the other dihydroxyaryl compounds having formula (I) which can optionally also be used is preferably between 99 mol % (Ia) to 1 mol % (I) and 2 mol % (Ia) to 98 mol % (I), preferably between 99 mol % (Ia) to 1 mol % (I) and 10 mol % (Ia) to 90 mol % (I) and in particular between 99 mol % (Ia) to 1 mol % (I) and 30 mol % (Ia) to 70 mol % (I).

A most particularly preferred copolycarbonate can be produced using 1,1-bis-(4-hydroxyphenyl)-3,3,5-trimethylcyclohexane and 2,2-bis-(4-hydroxyphenyl)propane as dihydroxyaryl compounds having formula (Ia) and (I).

Suitable carbonic acid derivatives can for example be diaryl carbonates compounds having the general formula (II)

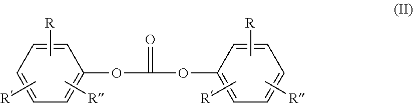

wherein
R, R′ and R″ are the same or different and mutually independently stand for hydrogen, linear or branched C₁-C₃₄ alkyl, C₇-C₃₄ alkylaryl or C₆-C₃₄ aryl, R can also denote —COO—R′″, wherein R′″ stands for hydrogen, linear or branched C₁-C₃₄ alkyl, C₇-C₃₄ alkylaryl or C₆-C₃₄ aryl.

Preferred diaryl carbonates are for example diphenyl carbonate, methylphenyl phenyl carbonates and di(methylphenyl) carbonates, 4-ethylphenyl phenyl carbonate, di-(4-ethylphenyl) carbonate, 4-n-propylphenyl phenyl carbonate, di-(4-n-propylphenyl) carbonate, 4-isopropylphenyl phenyl carbonate, di-(4-isopropylphenyl) carbonate, 4-n-butylphenyl phenyl carbonate, di-(4-n-butylphenyl) carbonate, 4-isobutylphenyl phenyl carbonate, di-(4-isobutylphenyl) carbonate, 4-tert-butylphenyl phenyl carbonate, di-(4-tert-butylphenyl) carbonate, 4-n-pentylphenyl phenyl carbonate, di-(4-n-pentylphenyl) carbonate, 4-n-hexylphenyl phenyl carbonate, di-(4-n-hexylphenyl) carbonate, 4-isooctylphenyl phenyl carbonate, di-(4-isooctylphenyl) carbonate, 4-n-nonylphenyl phenyl carbonate, di-(4-n-nonylphenyl) carbonate, 4-cyclohexylphenyl phenyl carbonate, di-(4-cyclohexylphenyl) carbonate, 4-(1-methyl-1-phenylethyl)phenyl phenyl carbonate, di-[4-(1-methyl-1-phenylethyl)phenyl]carbonate, biphenyl-4-yl phenyl carbonate, di-(biphenyl-4-yl) carbonate, 4-(1-naphthyl)phenyl phenyl carbonate, 4-(2-naphthyl)phenyl phenyl carbonate, di-[4-(1-naphthyl)phenyl]carbonate, di-[4-(2-naphthyl)phenyl]carbonate, 4-phenoxyphenyl phenyl carbonate, di-(4-phenoxyphenyl) carbonate, 3-pentadecylphenyl phenyl carbonate, di-(3-pentadecylphenyl) carbonate, 4-tritylphenyl phenyl carbonate, di-(4-tritylphenyl) carbonate, methylsalicylate phenyl carbonate, di(methylsalicylate) carbonate, ethylsalicylate phenyl carbonate, di(ethylsalicylate) carbonate, n-propylsalicylate phenyl carbonate, di-(n-propylsalicylate) carbonate, isopropylsalicylate phenyl carbonate, di(isopropylsalicylate) carbonate, n-butylsalicylate phenyl carbonate, di-(n-butylsalicylate) carbonate, isobutylsalicylate phenyl carbonate, di(isobutylsalicylate) carbonate, tert-butylsalicylate phenyl carbonate, di-(tert-butylsalicylate) carbonate, di(phenylsalicylate) carbonate and di(benzylsalicylate) carbonate.

Particularly preferred diaryl compounds are diphenylcarbonate, 4-tert-butylphenyl phenyl carbonate, di-(4-tert-butylphenyl) carbonate, biphenyl-4-yl phenyl carbonate, di(biphenyl-4-yl) carbonate, 4-(1-methyl-1-phenylethyl)phenyl phenyl carbonate, di-[4-(1-methyl-1-phenylethyl)phenyl]carbonate and di(methylsalicylate) carbonate.

Diphenyl carbonate is most particularly preferred.

Both one diaryl carbonate and also various diaryl carbonates can be used.

One or more monohydroxyaryl compound(s) that have not been used to produce the diaryl carbonate(s) used, for example, can additionally be used as chain terminators for controlling or modifying the end groups. Suitable examples are those having the general formula (III)

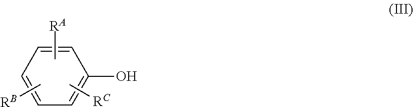

wherein
R^{A} stands for linear or branched C₁-C₃₄ alkyl, C₇-C₃₄ alkylaryl, C₆-C₃₄ aryl or for —COO—R^{D}, wherein R^{D} stands for hydrogen, linear or branched C₁-C₃₄ alkyl, C₇-C₃₄ alkylaryl or C₆-C₃₄ aryl, and
R^{B}, R^{C} are the same or different and mutually independently stand for hydrogen, linear or branched C₁-C₃₄ alkyl, C₇-C₃₄ alkylaryl or C₆-C₃₄ aryl.

Such monohydroxyaryl compounds are for example 1-, 2- or 3-methylphenol, 2,4-dimethylphenol, 4-ethylphenol, 4-n-propylphenol, 4-isopropylphenol, 4-n-butylphenol, 4-isobutylphenol, 4-tert-butylphenol, 4-n-pentylphenol, 4-n-hexylphenol, 4-isooctylphenol, 4-n-nonylphenol, 3-pentadecylphenol, 4-cyclohexylphenol, 4-(1-methyl-1-phenylethyl)phenol, 4-phenylphenol, 4-phenoxyphenol, 4-(1-naphthyl)phenol, 4-(2-naphthyl)phenol, 4-tritylphenol, methylsalicylate, ethylsalicylate, n-propylsalicylate, isopropylsalicylate, n-butylsalicylate, isobutylsalicylate, tert-butylsalicylate, phenylsalicylate and benzylsalicylate.

4-tert-Butylphenol, 4-isooctylphenol and 3-pentadecylphenol are preferred.

Suitable branching agents can be compounds having three or more functional groups, preferably those having three or more hydroxyl groups.

Suitable compounds having three or more phenolic hydroxyl groups are for example phloroglucinol, 4,6-dimethyl-2,4,6-tri-(4-hydroxyphenyl)heptene-2,4,6-dimethyl-2,4,6-tri-(4-hydroxyphenyl)heptane, 1,3,5-tri-(4-hydroxyphenyl)benzene, 1,1,1-tri-(4-hydroxyphenyl)ethane, tri-(4-hydroxyphenyl)phenylmethane, 2,2-bis-(4,4-bis-(4-hydroxyphenyl)cyclohexyl]propane, 2,4-bis-(4-hydroxyphenyl isopropyl)phenol and tetra-(4-hydroxyphenyl)methane.

Other suitable compounds having three or more functional groups are for example 2,4-dihydroxybenzoic acid, trimesic acid (trichloride), cyanuric acid trichloride and 3,3-bis-(3-methyl-4-hydroxyphenyl)-2-oxo-2,3-dihydroindole.

Preferred branching agents are 3,3-bis-(3-methyl-4-hydroxyphenyl)-2-oxo-2,3-dihydroindole and 1,1,1-tri-(4-hydroxyphenyl)ethane.

Polyalkylene terephthalates are suitable in preferred embodiments of the invention as poly- or copolycondensates of terephthalic acid. Suitable polyalkylene terephthalates are for example reaction products of aromatic dicarboxylic acids or reactive derivatives thereof (for example dimethyl esters or anhydrides) and aliphatic, cycloaliphatic or araliphatic diols and mixtures of these reaction products.

Preferred polyalkylene terephthalates can be produced by known methods from terephthalic acid (or reactive derivatives thereof) and aliphatic or cycloaliphatic diols having 2 to 10 C atoms (Kunststoff-Handbuch, Vol. VIII, p. 695 ff, Karl-Hanser-Verlag, Munich 1973).

Preferred polyalkylene terephthalates contain at least 80 mol %, preferably 90 mol % terephthalic acid radicals, relative to the dicarboxylic acid component, and at least 80 mol %, preferably at least 90 mol % ethylene glycol and/or butanediol-1,4 radicals, relative to the diol component.

The preferred polyalkylene terephthalates can contain in addition to terephthalic acid radicals up to 20 mol % of radicals of other aromatic dicarboxylic acids having 8 to 14 C atoms or aliphatic dicarboxylic acids having 4 to 12 C atoms, such as for example radicals of phthalic acid, isophthalic acid, naphthalene-2,6-dicarboxylic acid, 4,4′-diphenyl dicarboxylic acid, succinic acid, adipic acid, sebacic acid, azelaic acid, cyclohexane diacetic acid.

The preferred polyalkylene terephthalates can contain in addition to ethylene or butanediol-1,4 glycol radicals up to 20 mol % of other aliphatic diols having 3 to 12 C atoms or cycloaliphatic diols having 6 to 21 C atoms, for example radicals of propanediol-1,3,2-ethylpropanediol-1,3, neopentyl glycol, pentanediol-1,5, hexanediol-1,6, cyclohexane dimethanol-1,4,3-methylpentanediol-2,4,2-methylpentanediol-2,4,2,2,4-trimethylpentanediol-1,3 and 2-ethylhexanediol-1,6,2,2-diethylpropanediol-1,3, hexanediol-2,5,1,4-di-([beta]-hydroxyethoxy)-benzene, 2,2-bis-(4-hydroxycyclohexyl)propane, 2,4-dihydroxy-1,1,3,3-tetramethylcyclobutane, 2,2-bis-(3-[beta]-hydroxyethoxyphenyl)propane and 2,2-bis-(4-hydroxypropoxyphenyl)propane (cf. DE-OS 24 07 674, 24 07 776, 27 15 932).

The polyalkylene terephthalates can be branched by incorporating relatively small amounts of trihydric or tetrahydric alcohols or tribasic or tetrabasic carboxylic acids, as described for example in DE-OS 19 00 270 and U.S. Pat. No. 3,692,744. Examples of preferred branching agents are trimesic acid, trimellitic acid, trimethylol ethane and propane and pentaerythritol.

No more than 1 mol % of the branching agent, relative to the acid component, is preferably used.

Polyalkylene terephthalates produced solely from terephthalic acid and reactive derivatives thereof (for example dialkyl esters thereof) and ethylene glycol and/or butanediol-1,4, and mixtures of these polyalkylene terephthalates are particularly preferred.

Preferred polyalkylene terephthalates are also copolyesters produced from at least two of the aforementioned acid components and/or from at least two of the aforementioned alcohol components, particularly preferred copolyesters being poly(ethylene glycol/butanediol-1,4) terephthalates.

By preference the polyalkylene terephthalates preferably used as the component have an intrinsic viscosity of approximately 0.4 to 1.5 dl/g, preferably 0.5 to 1.3 dl/g, measured in each case in phenol/o-dichlorobenzene (1:1 parts by weight) at 25° C.

The plastic film having the laser printed security feature(s) that is used preferably has a specific surface resistance of 10⁵ to 10¹⁴Ω, preferably 10⁷ to 10¹³Ω, particularly preferably 10⁸ to 10¹²Ω. The specific surface resistance in Ω is determined in accordance with DIN IEC 93.

In a preferred embodiment of the laminar structure according to the invention a suitable plastic film for the layer between the two filled layers is one having a laminar structure comprising at least three layers, namely
(1) at least one inner layer consisting of a thermoplastic having a Vicat softening point B/50₍ᵢₙₙₑᵣ₎ and
(2) at least one lower and at least one upper layer (outer layers) consisting of a thermoplastic having a Vicat softening point B/50₍ₒᵤₜₑᵣ₎, which is lower than the Vicat softening point B/50₍ᵢₙₙₑᵣ₎.

The Vicat softening point B/50 of a thermoplastic is the Vicat softening point B/50 measured in accordance with ISO 306 (50 N; 50° C./h).

A most particularly preferred multi-layer plastic film for the layer between the two filled layers having a laminar structure of this type comprises three layers, namely an inner layer and a lower and an upper layer, mutually independently consisting of the aforementioned thermoplastics.

If the multi-layer plastic film is the plastic film laser printed with the security feature(s), then preferably at least the lower or the upper layer, by preference the lower and the upper layer of the multi-layer plastic film for the layer between the two filled layers has a specific surface resistance of 10⁵ to 10¹⁴Ω, preferably 10⁷ to 10¹³Ω, particularly preferably 10⁸ to 10¹²Ω.

In these multi-layer structures of the plastic film for the layer between the two filled layers the Vicat softening point B/50₍ₒᵤₜₑᵣ₎ is preferably at least 5° C. lower, by preference at least 10° C. lower than the Vicat softening point B/50₍ᵢₙₙₑᵣ₎.

In order to obtain the specific surface resistance it is further preferable for the thermoplastic composition of the plastic film having the laser printed security feature(s) that is used to contain for example an additive selected from tertiary or quaternary, preferably quaternary ammonium or phosphonium salts of a partially fluorinated or perfluorinated organic acid or quaternary ammonium or phosphonium hexafluorophosphates, preferably of a partially fluorinated or perfluorinated alkyl sulfonic acid, preferably a perfluoroalkyl sulfonic acid.

Such additives and their use as antistatics are described in the literature (cf. DE-A 25 06 726, EP-A 1 290 106, EP 897 950 A2 or U.S. Pat. No. 6,372,829).

Examples of anions of such salts which are suitable as additives include partially fluorinated or perfluorinated alkyl sulfonates, cyanoperfluoroalkane sulfonylamides, bis(cyano)perfluoroalkylsulfonylmethides, bis(perfluoroalkylsulfonyl)imides, bis(perfluoroalkylsulfonyl)methides, tris(perfluoroalkylsulfonyl)methides or hexafluorophosphates. Partially fluorinated or perfluorinated alkyl sulfonates are particularly preferred, perfluoroalkyl sulfonates being most particularly preferred. Examples of cations of such salts which according to the invention are suitable as additives preferably include acyclic or cyclic tertiary or quaternary ammonium or phosphonium cations. Examples of suitable cyclic cations include pyridinium, pyridazidinium, pyrimidinium, pyrazinium, imidazolium, pyrazolium, thiazolium, oxazolium or thiazolium cations. Examples of suitable acyclic cations include those integrated into formula (IV) below.

Particularly preferred examples of suitable quaternary ammonium or phosphonium salts of a perfluoroalkyl sulfonic acid are those having the general formula (IV)

R¹—SO₃XR²R³R⁴R⁵ (IV)

in which
X denotes N or P, preferably N,
R¹ denotes partially fluorinated or perfluorinated cyclic or linear, branched or unbranched carbon chains having 1 to 30 carbon atoms, preferably 4 to 8 carbon atoms, in the case of cyclic radicals preferably those having 5 to 7 carbon atoms,
R² denotes unsubstituted or halogen-, hydroxy-, cycloalkyl- or alkyl-substituted, in particular C₁ to C₃ alkyl- or C₅ to C₇ cycloalkyl-substituted, cyclic or linear, branched or unbranched carbon chains having 1 to 30 carbon atoms, preferably 3 to 10 carbon atoms, in the case of cyclic radicals preferably those having 5 to 7 carbon atoms, particularly preferably propyl, 1-butyl, 1-pentyl, hexyl, isopropyl, isobutyl, tert-butyl, neopentyl, 2-pentyl, isopentyl, isohexyl, cyclohexyl, cyclohexylmethyl and cyclopentyl,
R³, R⁴, R⁵ mutually independently denote unsubstituted or halogen-, hydroxy-, cycloalkyl- or alkyl-substituted, in particular C₁ to C₃ alkyl- or C₅ to C₇ cycloalkyl-substituted, cyclic or linear, branched or unbranched carbon chains having 1 to 30 carbon atoms, preferably 1 to 10 carbon atoms, in the case of cyclic radicals preferably those having 5 to 7 carbon atoms, particularly preferably methyl, ethyl, propyl, 1-butyl, 1-pentyl, hexyl, 1-isopropyl, isobutyl, tert-butyl, neopentyl, 2-pentyl, isopentyl, isohexyl, cyclohexyl, cyclohexylmethyl and cyclopentyl.

The ammonium or phosphonium salts in which
X denotes N or P, preferably N,
R¹ denotes perfluorinated linear or branched carbon chains having 1 to 30 carbon atoms, preferably 4 to 8 carbon atoms,
R² mutually independently denotes halogenated or non-halogenated linear or branched carbon chains having 1 to 30 carbon atoms, preferably 3 to 10 carbon atoms, particularly preferably propyl, 1-butyl, 1-pentyl, hexyl, isopropyl, isobutyl, tert-butyl, neopentyl, 2-pentyl, isopentyl, isohexyl,
R³, R⁴, R⁵ mutually independently denote halogenated or non-halogenated linear or branched carbon chains having 1 to 30 carbon atoms, preferably 1 to 10 carbon atoms, particularly preferably methyl, ethyl, propyl, 1-butyl, 1-pentyl, hexyl, isopropyl, isobutyl, tert-butyl, neopentyl, 2-pentyl, isopentyl, isohexyl
   are a preferred selection.

Preferred suitable quaternary ammonium or phosphonium salts are:
Perfluorooctane sulfonic acid tetrapropyl ammonium salt,
Perfluorobutane sulfonic acid tetrapropyl ammonium salt,
Perfluorooctane sulfonic acid tetrabutyl ammonium salt,
Perfluorobutane sulfonic acid tetrabutyl ammonium salt,
Perfluorooctane sulfonic acid tetrapentyl ammonium salt,
Perfluorobutane sulfonic acid tetrapentyl ammonium salt,
Perfluorooctane sulfonic acid tetrahexyl ammonium salt,
Perfluorobutane sulfonic acid tetrahexyl ammonium salt,
Perfluorobutane sulfonic acid trimethyl neopentyl ammonium salt,
Perfluorooctane sulfonic acid trimethyl neopentyl ammonium salt,
Perfluorobutane sulfonic acid dimethyl dineopentyl ammonium salt,
Perfluorooctane sulfonic acid dimethyl dineopentyl ammonium salt,
N-Methyl tripropyl ammonium perfluorobutyl sulfonate,
N-Ethyl tripropyl ammonium perfluorobutyl sulfonate,
Tetrapropyl ammonium perfluorobutyl sulfonate,
Diisopropyl dimethyl ammonium perfluorobutyl sulfonate,
Diisopropyl dimethyl ammonium perfluorooctyl sulfonate,
N-Methyl tributyl ammonium perfluorooctyl sulfonate,
Cyclohexyl diethyl methyl ammonium perfluorooctyl sulfonate,
Cyclohexyl trimethyl ammonium perfluorooctyl sulfonate,
   and the corresponding phosphonium salts. Ammonium salts are preferred.

One or more of the aforementioned quaternary ammonium or phosphonium salts, in other words including blends, can preferably also be used.

Perfluorooctane sulfonic acid tetrapropyl ammonium salt, perfluorooctane sulfonic acid tetrabutyl ammonium salt, perfluorooctane sulfonic acid tetrapentyl ammonium salt, perfluorooctane sulfonic acid tetrahexyl ammonium salt and perfluorooctane sulfonic acid dimethyl diisopropyl ammonium salt and the corresponding perfluorobutane sulfonic acid salts are most particularly suitable.

Perfluorobutane sulfonic acid dimethyl diisopropyl ammonium salt (diisopropyl dimethyl ammonium perfluorobutyl sulfonate) is used in a most particularly preferred embodiment.

The specified salts are known or can be produced by known methods. The salts of the sulfonic acids can be prepared for example by mixing equimolar amounts of free sulfonic acid and the hydroxyl form of the corresponding cation in water at room temperature and concentrating the solution to small volume. Other production methods are described for example in DE-A 1 966 931 and NL-A 7 802 830.

The specified salts are preferably added to the thermoplastics in amounts of 0.001 to 2 wt. %, preferably 0.1 to 1 wt. %, before shaping into the plastic film, which can be done by extrusion or coextrusion, for example.

Other conventional additives and accessory agents (e.g. auxiliary substances and reinforcing materials) known to the person skilled in the art can also be added to the thermoplastics.

The filler in the filled layers is preferably mutually independently a coloured pigment or another filler for producing a translucency in the filled layers, preferably titanium dioxide, zirconium dioxide, barium sulfate or glass fibres.

The filled layers and the filled films used for their production are preferably ones having a transmission in the visible wavelength range from 380 nm to 780 nm of less than 50%, preferably less than 35%, particularly preferably less than 25%, in most particularly preferred embodiments less than 15%.

The resulting translucency of the filled layers surrounding the printed watermark strengthens the feature that the printed watermark is only revealed when the laminar structure is held up to the light, i.e. it is more clearly discernible than when the laminar structure is viewed from above with no back light.

The specified fillers are preferably added to the thermoplastics in amounts of 2 to 60 wt. %, particularly preferably 20 to 40 wt. %, relative to the total weight of filler and thermoplastic material, before shaping into the plastic film, which can be done by extrusion or coextrusion, for example.

If the watermark(s) is (are) applied by laser printing to at least one of the two filled films, in preferred embodiments this filled film can contain both at least one of the aforementioned fillers and also one of the aforementioned salts as additives in the corresponding aforementioned amounts.

The plastic films for use according to the invention—both for the filled films and also the film for the optionally present layer between the two filled layers—preferably have a thickness of 55 μm to 750 μm, particularly preferably 100 μm to 300 μm. In preferred embodiments of the invention, in which the plastic film for the layer between the two filled layers is a laminar structure comprising at least three layers, the ratio of the film thickness of the inner layer or the overall film thickness of optionally several inner layers to the film thickness of the lower and upper layer or to the overall film thickness of optionally several lower and upper layers is 1:1:1 to 20:1:1, preferably 2:1:1 to 5:1:1.

The laser printed watermark(s) in the laminar structure according to the invention can be a black-and-white or colour impression, which can be mono-coloured or multicoloured or in the case of a black-and-white impression in various shades of grey or in black only. A further strengthening of the feature that the printed watermark is only revealed when the laminar structure is held up to the light, i.e. it is more clearly discernible then when the laminar structure is viewed from above with no back light, can be obtained by printing the watermark with a colour such that the part of the plastic printed with the watermark is significantly less translucent than the unprinted plastic surrounding the watermark. The laser printed watermark(s) in the laminar structure according to the invention is (are) therefore preferably a sharp black-and-white impression with few shades of grey. The difference in transmission in the visible wavelength range from 380 nm to 780 nm between the surrounding plastic and the part of the plastic printed with the watermark is preferably 10% to 80%, particularly preferably 15% to 75%, in most particularly preferred embodiments when printed on a transparent plastic film 50 to 75%.

The laser printed watermark(s) in the laminar structure according to the invention is (are) preferably one or more part-surface impressions, preferably one or more individual impressions. Within the context of the invention the term individual means that the design of the impression, in particular its form, can vary from one laminar structure to the next. For example, an individual impression within the context of the invention can be understood to be one which in a personalised identity document has some or all of the individual personalising identification features, which can optionally be and preferably are different in each individual document.

The laminar structure according to the invention preferably has a further part-surface impression, preferably a colour laser printed part-surface impression, which unlike the laser printed watermark(s) can also be clearly seen when the laminar structure is viewed from above with no back light. This impression preferably comprises individual personalising identification features, such as for example a portrait print for a person's photograph and/or other identification features such as fingerprints, name, address, date of birth, place of birth and/or an identification number, such as for example an identity card number, account number, credit card number, etc. In particularly preferred embodiments of the laminar structure according to the invention this part-surface impression, preferably part-surface colour laser printed impression, is completely or partly identical in form to the laser printed watermark. By way of example, an embodiment of such a laminar structure according to the invention could have for example a colour laser printed portrait print for a person's photograph and the same portrait print as a laser printed watermark, preferably as a black-and-white impression.

Such a further part-surface impression can preferably be printed on at least one of the outer-facing sides in the laminar structure according to the invention or on at least one side of an additional transparent layer applied on the outside to one of the filled layers.

A further preferred embodiment of the laminar structure according to the invention is therefore one in which a further layer consisting of at least one thermoplastic is applied to at least one layer, preferably to one of the two filled layers, which further layer is preferably transparent and displays such a further part-surface impression. Such an additional layer can be formed from at least one of the aforementioned thermoplastics, preferably independently of the other layers.

The laminar structure according to the invention can additionally have further layers, such as for example adhesive layers, coupling layers, protective and/or top layers.

The laminar structure according to the invention is preferably suitable as a component of security or value documents, preferably personalised security documents (“personalised identity documents”), most particularly preferably those in the form of glued or laminated multi-layer composites in the form of plastic cards, such as for example identity cards, passports, driving licences, credit cards, bank cards or other identification or payment documents, etc., to increase their protection against forgery.

The present invention therefore also provides a security or value document, preferably a personalised security document, particularly preferably one in the form of a glued or laminated, preferably laminated multi-layer composite in the form of a plastic card containing at least one laminar structure according to the invention.

Such a security or value document according to the invention can be produced according to the invention by forming and then gluing and/or laminating the corresponding film stack containing the correspondingly pre-printed plastic film(s). Within the context of the production of security or value documents, lamination, preferably under pressure and at temperatures above the softening point of the film(s), is generally preferred to simple gluing, since lamination makes it more difficult to open the multi-layer composite subsequently without destroying the watermarks or may even prevent it altogether. However, further layers can also subsequently be glued onto an initially laminated multi-layer composite or optionally applied by other means, optionally by spraying or by knife application.

The present invention therefore also provides a process for producing a security or value document according to the invention, characterised in that that at least
a) one plastic film consisting of at least one thermoplastic and optionally at least one filler is laser printed on one side with at least one watermark, and
b) the plastic film printed with at least one watermark is provided on the other side or at least one further plastic film consisting of at least one thermoplastic and optionally at least one filler is provided on one side with at least one further part-surface impression, preferably laser printed with at least one further part-surface impression, particularly preferably colour laser printed with at least one part-surface colour impression, which can clearly be seen even when the laminar structure is viewed from above with no back light, and
c) a film stack is formed containing
   i) at least one first plastic film consisting of at least one thermoplastic and at least one filler (“first filled film”), and
   ii) at least one further plastic film consisting of at least one thermoplastic and at least one filler (“further filled film”), and
   iii) optionally at least one transparent plastic film consisting of at least one thermoplastic between the first and the further filled film (“intermediate film”),
      wherein the laser printed watermark(s) is (are) located on at least one of the films specified in i), ii) or iii) and if the laser printed watermark(s) is (are) located on the intermediate film specified in iii) then this film is imperatively included in the film stack, and the films are arranged in such a way that the laser printed watermark(s) is (are) located between the first and the further filled film, and
   iv) optionally at least one further transparent plastic film resting on one of the filled films, which displays the further laser printed part-surface impression, preferably colour laser printed part-surface colour impression (“impression film”), and
   v) optionally further protective plastic films (“protective film(s)”), and
      the film stack is then laminated and/or glued, preferably laminated. The laminated film stack is then optionally also trimmed to a specific shape, e.g. card shape. This can also be done prior to lamination and/or gluing, however.

Some preferred embodiments of laminar structures according to the invention for the production of a security or value document and the production thereof are described below, this description being provided by way of example and not being intended as any limitation whatsoever of the invention.

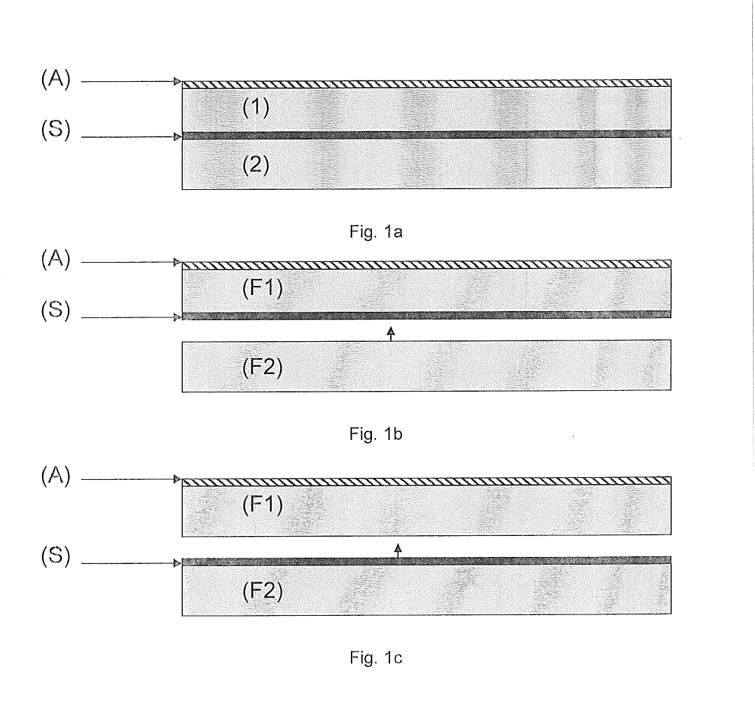

In a simple embodiment by way of example of the laminar structure according to the invention for a security or value document produced according to the invention such a structure has a first and a second filled layer (1) and (2), between which there is a laser printed watermark (S). The laminar structure can have a further part-surface impression (A) which is clearly discernible when viewed from above. A schematic view of such an embodiment is provided in FIG. 1a. A security or value document containing such a laminar structure can be produced according to the invention on the one hand by printing one side of a first filled film (F1) with the watermark (S) and printing the other side with the further impression (A), laying the second filled film (F2) on the side with the printed watermark (S) (cf. FIG. 1b) and then laminating the film stack. On the other hand a security or value document containing such a laminar structure can be produced according to the invention by printing a first filled film (F1) on one side with the further impression (A) and printing a second filled film (F2) on one side with the watermark (S), laying the two films on top of each other such that the side of the second filled film (F2) printed with the watermark (S) is facing inwards and the side of the first filled film (F1) printed with the further impression (A) is facing outwards (cf. FIG. 1c) and then laminating the film stack. In both cases the laminar structure according to the invention is a two-layer structure, regardless of whether the two filled films used differ in their composition.

Within the context of the invention the term layer thus also describes such a component of a laminar structure formed from a film as part of the production process, regardless of whether it is subsequently possible to distinguish between adjacent layers in this laminar structure.

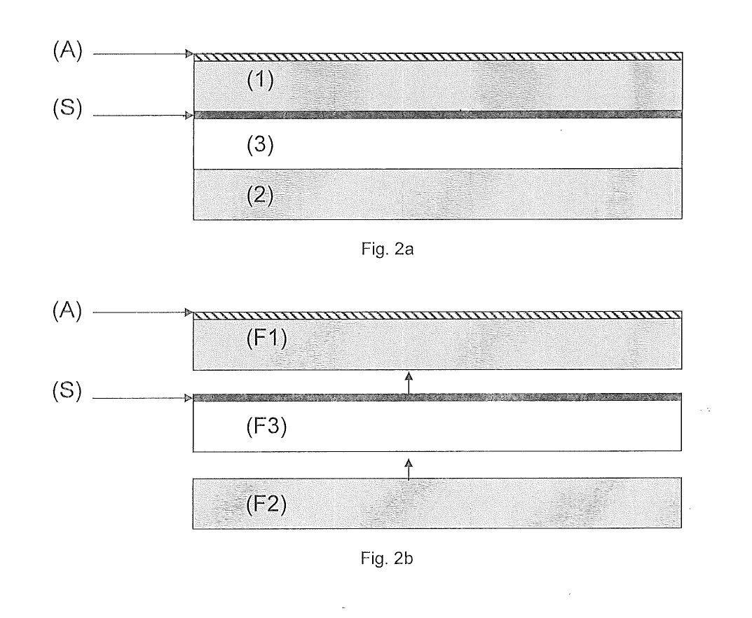

In another embodiment by way of example of the laminar structure according to the invention for a security or value document produced according to the invention such a structure has a first and a second filled layer (1) and (2) and at least one further layer consisting of at least one thermoplastic (3) between the two filled layers (1) and (2), wherein a laser printed watermark (S) is contained between the two filled layers (1) and (2). The laminar structure can have a further part-surface impression (A) which is clearly discernible when viewed from above. A schematic view of such an embodiment is provided in FIG. 2a. A security or value document containing such a laminar structure can be produced according to the invention by printing one side of a transparent plastic film consisting of at least one thermoplastic (F3) with the watermark (S) and printing one side of at least one of the two filled films (F1) or (F2) with the further impression (A). The films are arranged in a film stack in such a way that the film (F3) printed with the watermark (S) lies between the two filled films (F1) and (F2) and the side of the filled film (F1) or (F2) printed with the further impression (A) faces outwards (cf. FIG. 2b). This film stack is then laminated.

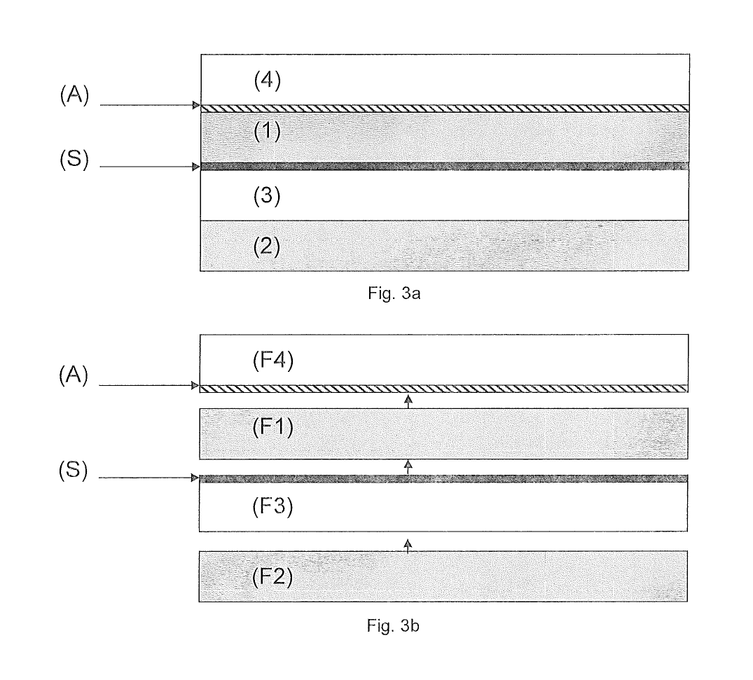

In a further embodiment by way of example of the laminar structure according to the invention for a security or value document produced according to the invention such a structure has a first and a second filled layer (1) and (2) and at least one further layer consisting of at least one thermoplastic (3) between the two filled layers (1) and (2), wherein a laser printed watermark (S) is contained between the two filled layers. The laminar structure contains at least one further layer consisting of at least one thermoplastic (4), which is not positioned between the two filled layers (1) and (2) and which has a further part-surface impression (A) which is clearly discernible when viewed from above. A schematic view of such an embodiment is provided in FIG. 3a. A security or value document containing such a laminar structure can be produced according to the invention by printing one side of a transparent plastic film consisting of at least one thermoplastic (F3) with the watermark (S) and printing one side of a further film consisting of at least one thermoplastic (F4) with the further impression (A). The films are arranged in a film stack in such a way that the film printed with the watermark (S) lies between the two filled films and the film (F4) printed with the further impression (A) is laid on one of the two filled films (1) or (2) from the outside (cf. FIG. 3b). This film stack is then laminated.

By virtue of the personalisable watermarks as security features, the laminar structures according to the invention considerably increase the protection against forgery of the security or value documents according to the invention in which they are contained. A subsequent opening of the document and substitution of only the personalising identification features for example is no longer possible owing to the likewise personalised watermark as a security feature. A time-consuming embossing process is replaced by the simple printing of the watermarks, both allowing the watermarks to be personalised and also increasing the sharpness of detail of the watermark and thus offering additional protection against forgery. In addition the printed watermarks also withstand without damage the exposure to high temperatures during sealing in the form of lamination for example of a corresponding film stack, which is not necessarily the case with embossed watermarks. The laminar structures according to the invention also have the advantage of allowing security or value documents according to the invention having considerably greater protection against forgery owing to the individual watermarks as security features to be produced easily and cost-effectively directly at the point at which they are issued to the user, since only the correspondingly printable films, a laser printer and a laminator are necessary.

The following examples serve to illustrate the invention by way of example and should not be regarded as a limitation.

### EXAMPLES

The specific surface resistance in Ω was determined in accordance with DIN IEC 93. The roughness was determined in accordance with ISO 4288.

### Example 1

A polycarbonate film of thickness 250 μm based on Makrolon 3108® polycarbonate from Bayer MaterialScience AG and perfluorooctane sulfonic acid tetraethyl ammonium salt (Bayowet 248® from Bayer MaterialScience AG) as additive with a composition of 98.5 wt. % Makrolon 3108® and 1.5 wt. % Bayowet 248® was produced by extrusion at a composition temperature of 280° C. The specific surface resistance of the film was determined in accordance with DIN IEC 93 (Ω) and was 6.0 10¹²Ω.

An A4 film sample of this film was printed with an HP colour laser printer (printer model: HP Colour Laserjet 4500 DN). The film was printed on side number 2 (roughness R3z<9 μm).

Print sample: part-surface black-and-white print (portrait of a person)

Resolution of the print sample: 600 dpi.

The film was able to be printed without any difficulty and displayed a perfect printed image.

The printed film was placed between two further films of thickness 100 μm based on Makrolon 3108® polycarbonate from Bayer MaterialScience AG, which were coloured a translucent white colour by adding 15 wt. % TiO₂ as filler (“filled films”). These filled films had a transmission of 10% in the visible wavelength range from 380 nm to 780 nm.

The film stack was placed in a Bürkle laminating press and laminated under pressure and at elevated temperature. Lamination was performed with the following parameters:

Temperature: 175° C.

Low admission pressure during the heating-up time: 15 N/cm²

Heating-up period: 8 minutes

High pressure during lamination: 300 N/cm²

Lamination period: 2 minutes

The press was then cooled down. The pressure was maintained during the cooling period. The press opened when it reached a temperature of 38° C.

Cards were punched out of the laminated sheet in accordance with the card dimensions specified in ISO 7810.

The printed image in the laminated card displayed no adverse effects.

When the card was viewed under incident light the printed image inside the card could not be seen. Only when the card was viewed against a back light could the “hidden” printed image in the card be seen (watermark as a security feature).

### Example 2

### Production of a Plastic Identity Card (ID Card) with a Colour Portrait of the Cardholder and a Personalised Watermark as a Security Feature in the Card Which Reproduces the Same Portrait in Black and White

a) Another A4 film sample of the film produced in the manner described in Example 1 was printed with an HP colour laser printer (printer model: HP Colour Laserjet 4500 DN). The film was printed on side number 2 (roughness R3z<9 μm).

Print sample: colour portrait of the cardholder and other details (personal data, line pattern, etc.).

Resolution of the print sample: 600 dpi.

The film was able to be printed without any difficulty and displayed a perfect printed image.

b) Another A4 film sample of the film produced in the manner described in Example 1 was printed with an HP colour laser printer (printer model: HP Colour Laserjet 4500 DN). The film was printed on side number 2 (roughness R3z<9 μm).

Print sample: black-and-white portrait of the cardholder

Resolution of the print sample: 600 dpi.

The position of the black-and-white portrait was chosen such that the portraits did not overlap when the film was laid on top of the colour printed film from a). The sole purpose of this was to make it easier to see the watermark in the finished ID card.

The film was able to be printed without any difficulty and displayed a perfect printed image.

c) The film printed in b) was placed between two further films of thickness 100 μm based on Makrolon 3108® polycarbonate from Bayer MaterialScience AG, which were coloured a translucent white colour by adding 15 wt. % TiO₂ as filler (“filled films”). These filled films had a transmission of 10% in the visible wavelength range from 380 nm to 780 nm.

d) The film printed in a) was laid on one side of the film pack comprising the films from b) and c). The film from a) was laid on the film pack with its printed side down. This also ensured that the printed portrait and print sample were protected from abrasion or other damage during subsequent use of the card.

e) The film stack was placed in a Bürlde laminating press and laminated under pressure and at elevated temperature. Lamination was performed with the following parameters:

Temperature: 175° C.

Low admission pressure during the heating-up time: 15 N/cm²

Heating-up period: 8 minutes

High pressure during lamination: 240 N/cm²

Lamination period: 2 minutes

The press was then cooled down. The pressure was maintained during the cooling period. The press opened when it reached a temperature of 38° C.

Cards were punched out of the laminated sheet in accordance with the card dimensions specified in ISO 7810.

The printed image in the laminated card displayed no adverse effects.

When the card was viewed under incident light the colour printed image from a) displayed no adverse effects or damage; the printed image inside the card could not be seen. Only when the card was viewed against a back light could the “hidden” printed image in the card be seen (watermark as a security feature).

1-14. (canceled)

15. A laminar structure comprising
a. a first layer comprising a first plastic film which comprises a thermoplastic and a filler and a further plastic film comprising a thermoplastic and a filler
b. a second layer comprising a first plastic film which comprises a thermoplastic and a filler and a further plastic film comprising a thermoplastic and a filler
c. a laser printed watermark between the first and second layers.

16. The laminar structure according to claim 15, wherein the laser printed watermark is disposed on at least one of the plastic films.

17. The laminar structure according to claim 15, wherein the laminar structure further comprises a transparent plastic film layer comprising a thermoplastic which is positioned between the first and second layers, wherein the laser printed watermark is disposed on the transparent plastic film.

18. The laminar structure according to claim 17, wherein the thermoplastic of the transparent plastic film layer is selected from the group consisting of ethylene-unsaturated monomers, polycondensates of bifunctional reactive compounds, and mixtures thereof.

19. The laminar structure according to claim 17, wherein the thermoplastic of the transparent plastic film layer is selected from the group consisting of polycarbonates, copolycarbonates based on diphenols, polyacrylates, copolyacrylates, polymethacrylates, copolymethacrylates, polymers with styrene, copolymers with styrene, polyurethanes, polyolefins, polycondensates, copolycondensates of terephthalic acid, and mixtures thereof.

20. The laminar structure according to claim 17, wherein the thermoplastic of the transparent plastic layer is selected from the group consisting of polycarbonates based on diphenols, copolycarbonates based on diphenols, and a blend of at least one polycarbonate or copolycarbonate and at least one poly- or copolycondensate of terephthalic acid.

21. The laminar structure according to claim 17, wherein the transparent plastic film layer comprises a second laminar structure comprising
a. an inner layer comprising a thermoplastic
b. a lower layer and an upper layer comprising a thermoplastic
wherein the thermoplastic in the lower and upper layer has a Vicat softening point lower than the Vicat softening point of the thermoplastic in the inner layer.

22. The laminar structure according to claim 17, wherein the transparent plastic film has a specific surface resistance of 10⁷ to 10¹³Ω.

23. The laminar structure according to claim 17, wherein the transparent plastic film comprises an additive selected from the group consisting of quaternary ammonium and phosphonium salts of a partially fluorinated or perfluorinated organic acid or quaternary ammonium or phosphonium hexafluorophosphates.

24. The laminar structure according to claim 15, wherein the thermoplastic of the first and second layers is, independently of one another, selected from the group consisting of ethylene-unsaturated monomers, polycondensates of bifunctional reactive compounds, and mixtures thereof.

25. The laminar structure according to claim 15, wherein the laser printed watermark is one or more part-surface impressions.

26. The laminar structure according to claim 15, wherein the filler in the first and second layers comprises a coloured pigment or another filler for producing a translucency in the first and second layers.

27. The laminar structure according to claim 26, wherein the filler in the first and second layers is selected from the group consisting of titanium dioxide, zirconium dioxide, barium sulphate, and glass fibres.

28. The laminar structure according to claim 15, wherein the laminar structure further comprises a second transparent layer which comprises a thermoplastic disposed on at least one of the first and second layers, and wherein the second transparent layer comprises at least one part-surface impression.

29. A security or value document comprising the laminar structure according to claim 15.

30. A personalized security document comprising the laminar structure according to claim 15.

31. A process for producing a security or value document comprising
a. providing a first plastic film comprising a thermoplastic and optionally at least one filler
b. laser printing a watermark on the first plastic film,
c. providing a second plastic film comprising a thermoplastic and optionally a filler, wherein the second plastic film is positioned overtop of the laser printed watermark and wherein the second plastic film comprises at least one part-surface impression,
d. forming a film stack comprising
i) the first plastic film,
ii) the second plastic film, and
iii) optionally a transparent plastic film comprising a thermoplastic positioned between the first and second plastic films,
wherein the laser printed watermark is disposed on at least one of the films specified in i), ii) or iii) and if the laser printed watermark is disposed on the transparent plastic film, the film stack is arranged such that the laser printed watermark is positioned between the first and the second plastic films, and
e. laminating and/or gluing the film stack.

32. The process according to claim 31, further comprising a second transparent plastic film disposed on one of the first and second films, wherein the second transparent plastic film displays the laser printed part-surface impression.

33. The process according to claim 31, further comprising at least one protective plastic film disposed on an exterior surface of the first or second plastic films.
